(19) United States
(12) Patent Application Publication
(10) Pub. No.: US 2022/0325086 A1
(43) Pub. Date: Oct. 13, 2022

(54) Propylene-Rich Thermoplastic Vulcanizate Compositions and Articles

(71) Applicant: Celanese International Corporation, Houston, TX (US)

(72) Inventors: Antonios K. Doufas, Houston, TX (US); Krishnan Anantha Narayana Iyer, Pearland, TX (US); Edward J. Blok, Huffman, TX (US); Narayanaswami Dharmarajan, Houston, TX (US); Zhifeng Bai, Houston, TX (US); Keishla R. Rivera Dones, Madison, WI (US); Ron Walker, Pearland, TX (US); Sudhin Datta, Houston, TX (US)

(21) Appl. No.: 17/639,958

(22) PCT Filed: Aug. 26, 2020
(86) PCT No.: PCT/US2020/047859

§ 371 Date: Mar. 3, 2022

Related U.S. Application Data
(60) Provisional application No. 62/895,674, filed on Sep. 4, 2019.

(51) Int. Cl. C08L 23/16; C08L 23/12

(52) U.S. Cl. CPC C08L 23/16; C08L 23/12; C08L 2205/22

(57) ABSTRACT

Thermoplastic vulcanizate compositions and articles exhibiting superior elastomeric performance and adhesive properties, and methods of making same are characterized by comprising a thermoplastic phase and a rubber phase. The thermoplastic phase comprises a thermoplastic polyolefin, and the rubber phase comprises an amorphous propylene-ethylene copolymer having: a Mₙ of from 20 kg/mol to 3,000 kg/mol, a M_{w}/Mₙ of 10.0 or lower, an ethylene percentage by weight of from about 2 wt. % to about 50 wt. %, a diene percentage by weight of from about 0 wt. % to about 21 wt. % and a heat of fusion of less than 5 J/g.

### CROSS-REFERENCE TO RELATED APPLICATIONS

This application claims the priority benefit of U.S. Ser. No. 62/895,674, filed Sep. 4, 2019, the disclosure of which is incorporated herein by reference.

### FIELD

The present disclosure relates to thermoplastic vulcanizate compositions and articles exhibiting superior elastomeric performance and adhesive properties, and methods of making same.

### BACKGROUND

Thermoplastic vulcanizates (TPVs) are a class of thermoplastic compositions that include cross-linked elastomer particles finely dispersed in a continuous thermoplastic phase. TPVs combine the elastomer phase's elastomeric properties with the processability of thermoplastics, and thus have wide application in consumer goods and industry. For example, TPVs may be used as auto parts, such as dashboards and bumpers, air ducts, weather seals, fluid seals, and other under the hood applications; as gears and cogs, wheels, and drive belts for machines; as cases and insulators for electronic devices; as fabric for carpets, clothes, and bedding, and as fillers for pillows and mattresses; and as expansion joints for construction. TPVs may be selected for a particular use due to their mechanical properties, such as hardness, tensile strength, modulus, and elongation at break, as well as their elastic performance, such as the TPV's resiliency.

In certain applications, TPVs with improved adhesion and tack, and improved tensile and elastic properties, are particularly desirable. For instance, seals and gaskets that improve water tightness and performance of vehicles, windows, as well as flexible piping suitable for, e.g., oil and gas application. Thus, there remains a need for new compositions of TPVs to optimize performance in certain applications.

### SUMMARY

The present disclosure relates to TPVs with improved adhesion and/or tack comprising a PEDM and/or PEM amorphous rubber, which imparts improved elastic, adhesion, and mechanical properties.

For example, a TPV composition comprising a thermoplastic phase that comprises a thermoplastic polyolefin; and a rubber phase. The rubber phase comprises an amorphous propylene-ethylene copolymer having a Mₙ of from 20 kg/mol to 3,000 kg/mol, a M_{w}/Mₙ of 10.0 or lower, an ethylene percentage by weight of from about 2 wt. % to about 50 wt. %, a diene percentage by weight of from about 0 wt. % to about 21 wt. % and a heat of fusion of less than 5 J/g.

Also disclosed is an article comprised of the PEDM and/or PEM wherein the article is selected from the group consisting of GCR weather seals, corner moldings, seals, gaskets, flexible pipe for petroleum application, and thermoplastic composite pipe suitable for petroleum applications.

A method can comprise introducing into a blender each of a thermoplastic phase that comprises a thermoplastic polyolefin; a rubber phase that comprises an amorphous propylene-ethylene copolymer having: a Mₙ of from 20 kg/mol to 3,000 kg/mol, a M_{w}/Mₙ of 10.0 or lower, an ethylene percentage by weight of from about 2 wt. % to about 50 wt. %, a diene percentage by weight of from about 0 wt. % to about 21 wt. % and a heat of fusion of less than 5 J/g; and dynamically vulcanizing at least a portion of the contents of the blender so as to form a thermoplastic vulcanizate.

### BRIEF DESCRIPTION OF THE DRAWINGS

The following FIGURE are included to illustrate certain aspects of the present disclosure, and should not be viewed as exclusive embodiments. The subject matter disclosed is capable of considerable modifications, alterations, combinations, and equivalents in form and function, as will occur to one of ordinary skill in the art and having the benefit of this disclosure.

The FIGURE is a graph illustrating tension set values of certain TPV compositions.

### DETAILED DESCRIPTION

The present disclosure relates to TPV compositions comprising a thermoplastic polyolefin and a propylene-ethylene copolymer. Such compositions may have excellent elastic recovery and exceptional adhesion, bonding and tack characteristics that are particularly suitable for automotive applications such as glass encapsulation, end caps, molded covers, cowl seals, hood-to-radiator seals, trunk and tailgate seals, lips for air ducts, and many other uses. Additional uses include applications requiring improved scratch and abrasion resistance.

More specifically, the thermoplastic vulcanizate compositions described herein are comprised of propylene-ethylene copolymers or propylene-ethylene-diene terpolymers having extremely low crystallinity, and a plastic phase with linear or optionally long chain branching topology and high melt strength. The copolymers are characterized by having a weight average molecular weight from about 50 kg/mol to 3,000 kg/mol, and an ethylene content between 2 wt. % and 50 wt. %, with low crystallinity. The resulting thermoplastic vulcanizates exhibit surprisingly superior elastic properties, such as low tension and compression sets, and high adhesive and bonding strength as compared to previously disclosed thermoplastic vulcanizates.

The thermoplastic vulcanizates of the present disclosure are suitable for the formation of articles where improved adhesion or tack properties are desired. For instance, weather seals, corner moldings, seals, gaskets, flexible pipe for petroleum application, and thermoplastic composite pipe suitable for petroleum applications.

Various terms as used herein are defined below. To the extent a term used in a claim is not defined below, it should be given the broadest definition persons in the pertinent art have given that term as reflected in one or more printed publications or issued patents.

The term “thermoplastic vulcanizate,” and grammatical variants thereof, including “thermoplastic vulcanizate composition,” “thermoplastic vulcanizate material,” or “TPV,” and the like, is broadly defined as any material that includes a dispersed, at least partially vulcanized, rubber component and a thermoplastic component (e.g., a polyolefinic thermoplastic resin). A TPV material can further include other ingredients, other additives, or combinations thereof. Examples of commercially available TPV material include SANTOPRENE™ thermoplastic vulcanizates available from ExxonMobil Chemical, Houston, Tex.

The term “vulcanizate,” and grammatical variants thereof, means a composition that includes some component (e.g., rubber) that has been vulcanized. The term “vulcanized,” and grammatical variants thereof, is defined herein in its broadest sense, as reflected in any issued patent, printed publication, or dictionary, and refers in general to the state of a composition after all or a portion of the composition (e.g., a crosslinkable rubber) has been subjected to some degree or amount of vulcanization (crosslinking). Accordingly, the term encompasses both partial and total vulcanization. A preferred type of vulcanization is “dynamic vulcanization,” discussed below, which also produces a “vulcanizate.” Also, in at least one specific embodiment, the term vulcanized refers to more than insubstantial vulcanization (e.g., curing or crosslinking) that results in a measurable change in pertinent properties (e.g., a change in the melt flow index (MFI) of the composition by 10% or more, according to any ASTM-1238 procedure). In at least one or more contexts, the term vulcanization encompasses any form of curing (or crosslinking), both thermal and chemical, that can be utilized in dynamic vulcanization.

The term “dynamic vulcanization,” and grammatical variants thereof, means vulcanization or curing of a curable rubber component blended with a thermoplastic component under conditions of shear at temperatures sufficient to plasticize the mixture. In at least one embodiment, the rubber component is simultaneously crosslinked and dispersed as micro-sized particles within the thermoplastic component. Depending on the degree of cure, the rubber component to thermoplastic component ratio, compatibility of the rubber component and thermoplastic component, the kneader type and the intensity of mixing (shear rate), other morphologies, such as co-continuous rubber phases in the plastic matrix, are possible.

The term “partially vulcanized,” and grammatical variants thereof (e.g., “at least partially vulcanized”), with reference to a rubber component is one wherein more than about 5 wt. % (wt. %) of the rubber component (e.g., crosslinkable rubber component) is extractable in boiling xylene, subsequent to vulcanization, preferably dynamic vulcanization (e.g., crosslinking of the rubber phase of the thermoplastic vulcanizate). For example, at least 5 wt. % and less than 20 wt. % or 30 wt. % or 50 wt. % of the rubber component can be extractable from the specimen of the thermoplastic vulcanizate in boiling xylene, encompassing any value and subset therebetween. The percentage of extractable rubber component can be determined by the technique set forth in U.S. Pat. No. 4,311,628, which is hereby incorporated by reference in its entirety.

As used herein, the “thermoplastic component,” and grammatical variants thereof, of the thermoplastic vulcanizates of the present disclosure refers to any material that is not a “rubber” and that is a polymer or polymer blend considered by persons skilled in the art as being thermoplastic in nature (e.g., a polymer that softens when exposed to heat and returns to its original condition when cooled to room temperature). The thermoplastic component may comprise one or more polyolefins, including polyolefin homopolymers and polyolefin copolymers. The polyolefinic thermoplastic component may comprise at least one of i) a polymer prepared from olefin monomers having 2 to 7 carbon atoms and/or ii) copolymer prepared from olefin monomers having 2 to 7 carbon atoms with a (meth)acrylate or a vinyl acetate. Illustrative polyolefins can be prepared from mono-olefin monomers including, but not limited to, ethylene, propylene, 1-butene, isobutylene, 1-pentene, 1-hexene, 1-octene, 3-methyl-1-pentene, 4-methyl-1-pentene, 5-methyl-1-hexene, mixtures thereof and copolymers thereof with (meth)acrylates and/or vinyl acetates. The polyolefin thermoplastic component may comprise polyethylene, polypropylene, propylene-ethylene copolymer, and any combination thereof. Preferably, the thermoplastic component is not vulcanized or not cross-linked.

As used herein, a “polymer” may be used to refer to homopolymers, copolymers, interpolymers, terpolymers, etc. When a polymer is referred to as comprising a monomer, the monomer is present in the polymer in the polymerized form of the monomer or in the derivative form of the monomer. Thus, when a polymer is said to comprise a certain percentage (e.g., wt. %) of a monomer, that percentage of monomer is based on the total amount of monomer units in all the polymer components of the composition or blend. That is, a polymer comprising 30 wt. % ethylene and 70 wt. % propylene is a polymer where 30 wt. % of the polymer is ethylene-derived units and 70 wt. % of the polymer is propylene-derived units.

As used herein and except as stated otherwise, the term “copolymer,” and grammatical variants thereof, refers to a polymer derived from two or more monomers (e.g., terpolymers, tetrapolymers, and the like).

For purposes of this disclosure, and unless otherwise indicated, a “composition” includes components of the composition and/or reaction products of two or more components of the composition.

Any thermoplastic vulcanizate of the present disclosure may be comprised of a rubber phase, a plastic phase, filler, oil, and a curing system, which are further described below. Without being limited by theory, it is hypothesized that the interfacial tension between the plastic phase and the rubber phase, as disclosed herein, is low enough to favor small rubber domains (e.g., on the order of 0.5-5 microns) with improved mechanical and adhesion properties. The high entanglement molecular weight of the rubber phase in PEDM-based TPVs as compared to EPDM-based TPVs results in higher chain mobility due to fewer entanglements per chain, that provides better adhesion and tack properties.

### Rubber Phase

The rubbers that may be employed to form the rubber phase include those polymers that are capable of being cured or crosslinked by a phenolic resin or a hydrosilylation curative (e.g., silane-containing curative), a peroxide with a co-agent, a moisture cure via silane grafting, or an azide and the like. Reference to a rubber may include mixtures of more than one rubber. The rubbers used in the compositions and methods of the present disclosure are preferably 100% propylene-ethylene copolymers and/or propylene-ethylene-(diene) copolymers/terpolymers (PE(D)Ms), and are substantially amorphous.

The various terpolymers and copolymers forming the rubber phase may be referred to as rubbers, and are polymerized from ethylene, propylene, and optionally a diene monomer. The comonomers may be linear or branched. Preferred linear comonomers include ethylene or C₃ to C₈ α-olefins, more preferably ethylene, propylene, 1-butene, 1-hexene, and 1-octene, even more preferably ethylene or propylene. Preferred branched comonomers include 4-methyl-1-pentene, 3-methyl-1-pentene, 2-ethyl-1-butene, and 3,5,5-trimethyl-1-hexene. The comonomers may include styrene.

The optional diene monomers may be conjugated or non-conjugated. Preferably, the dienes are non-conjugated. Dienes may include 5-ethylidene-2-norbornene; 5-vinyl-2-norbornene; divinylbenzene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; vinyl norbornene; dicyclopentadiene; and the like; and any combination thereof. Preferably, the diene may be 5-ethylidene-2-norbornene. Dienes may be present in amounts from about 0 wt. % to about 21 wt. %, preferably about 3 wt. % to about 12 wt. %, and even more preferably about 4 wt. % to about 10 wt. %, based on the total weight of the rubber.

The propylene-ethylene copolymer may have an ethylene amount of from about 2 wt. % to about 50 wt. %, preferably about 10 wt. % to 40 wt. %, and more preferably about 20 wt. % to about 30 wt. % based on the total weight of the rubber. The balance of the copolymer comprises propylene and, optionally, one or more dienes.

The copolymer rubbers may have a weight average molecular weight (Mw) of 5,000 kg/mol or less, and a number average molecular weight (Mn) that is about 50 kg/mol to about 3,000 kg/mol, preferably about 100 kg/mol to about 1,000 kg/mol, more preferably about 150 kg/mol to about 800 kg/mol and even more preferably about 300 kg/mol to about 600 kg/ml. The z-average molecular weight (Mz) may be 10,000 kg/mol or less, and the copolymer may have a g′ index of 0.95 or greater, measured at the weight average molecular weight (Mw) of the polymer using isotactic polypropylene as the baseline. Sizes may be determined by size exclusion chromatography, as is known in the art.

The copolymer rubbers described herein include one or more of the following characteristics, where measurement techniques of each are describe in detail below.

A dry Mooney viscosity (ML₍₁₊₄₎ at 125° C.) per ASTM D1646-17, that is about 10 MU to about 500 MU, preferably from about 50 MU to about 300 MU.

A molecular weight distribution index, Mw/Mn, also known as a polydispersity index (PDI), that is about 10.0 or lower, preferably about 8 or lower and most preferably about 4 or lower.

Percentage of crystallinity of the rubber as measured by differential scanning calorimetry that is from 0% to about 5%, preferably 0% to about 3%, and even more preferably from about 0% to about 2%. The degree of crystallinity is determined by dividing heat of fusion measured with the heat of fusion for 100% crystalline polypropylene, which has the value of 207 J/g. B. Wunderlich, Thermal Analysis, Academic Press, 1990. Pp. 417-431. Rubbers with low crystallinity may be referred to as amorphous rubbers. For instance, an amorphous rubber may have 0% crystallinity, or near 0% crystallinity, or about 2% crystallinity or less, or about 3% crystallinity or less, or less than or equal to 5% crystallinity.

A heat of fusion (H_{f}) in the range of 0 Joules per gram (J/g) to about 80 J/g, or preferably from 0 J/g to about 50 J/g, or even more preferably from 9 J/g to about 30 J/g

A glass transition temperature, as measured by differential scanning calorimetry, of from about −2° C. to about −25° C.

The copolymer rubbers may be manufactured or synthesized by using a variety of techniques. For example, the rubbers may be synthesized by employing solution, slurry, or gas phase polymerization techniques, or a combination thereof, preferably solution polymerization techniques. Copolymers of the present disclosure are preferably made with metallocene catalyst systems, as disclosed in U.S. Pat. No. 5,756,416, incorporated by reference herein. Exemplary catalysts include single-site catalysts including constrained geometry catalysts involving Group IV-VI metallocenes. However, post-metallocene or Ziegler-Natta systems, including vanadium catalysts, as disclosed in U.S. Pat. No. 5,783,645, hereby incorporated by reference, may be used. Other catalysts systems, such as the Brookhart catalyst system, may also be employed.

The rubber of the disclosed TPV compositions may be non-oil extended, or may be oil extended with 20 phr to 200 phr process oil or plasticizer, preferably 50 phr to 100 phr, where phr refers to weight parts per 100 weight parts of dry rubber. Suitable plasticizers include, but are not limited to, aliphatic acid esters or hydrocarbon plasticizer oils such as paraffinic oils, aromatic oils, naphthenic petroleum oils, and polybutene oils. A particularly preferred plasticizer is naphthenic oil, which is commercially available by Nynas under the trade name NYTEX™ 4700.

### Thermoplastic Phase

The thermoplastic continuous phase of the present invention may be a conventional polypropylene, polyethylene, or butene-1-based polymer or combination thereof. Preferably, the plastic phase is an olefinic thermoplastic polymer, such as a C₂-C₂₀ α-olefin thermoplastic polymer. The polypropylene may comprise a homopolymer, a random polymer, an impact copolymer polypropylene, or a combination thereof. The plastic phase can have a linear or branch chain topology. Preferably, a high melt strength, long chain branched homopolymer polypropylene is used.

The continuous phase may comprise semi-crystalline polypropylene comprising semi-crystalline thermoplastic polymers from the polymerization of monoolefin monomers (e.g., 2 to 10 carbon atoms) by a high pressure, low pressure, or intermediate pressure process: or by Ziegler-Natta catalysts, or by metallocene catalysts. It may have any tacticity (e.g., isotactic and syndiotactic) or be a copolymer such as impact modified polypropylene or random copolymer polypropylene. Desirably the monoolefin monomers converted to repeat units are at least 80%, 85% or 93% propylene. The polypropylene can be a homopolymer, an in-reactor or extruder blend impact copolymer polypropylene, isotactic polypropylene, syndiotactic polypropylene, and other prior art propylene copolymers. Desirably, the polypropylene has a melting temperature peak of at least 110° C., preferably at least 160° C., and a heat of fusion of at least 50 J/mol, or preferably at least 115 J/mol, or preferably at least 135 J/mol, or at least 145 J/mol. Desirably, the polypropylene has a crystallinity of at least 25 wt. % or more (such as about 55 wt. % or more, such as about 65 wt. % or more, or such as about 70 wt. % or more). Crystallinity may be determined by differential scanning calorimetry (DSC) by dividing the heat of fusion (H_{f}) of a sample by the heat of fusion of a 100% crystalline polymer, which is assumed to be 209 joules/gram for polypropylene.

Exemplary thermoplastic polymers include the family of polyolefin resins, polyesters (such as polyethylene terephthalate, polybutylene terephthalate), polyamides (such as nylons), polycarbonates, styrene-acrylonitrile copolymers, polystyrene, polystyrene derivatives, polyphenylene oxide, polyoxymethylene, and fluorine-containing thermoplastics. The preferred thermoplastic resins are crystallizable polyolefins that are formed by polymerizing C₂ to C₂.% olefins such as, but not limited to, ethylene, propylene and C₄ to C₂ α-olefins, such as 1-butene, 1-hexene, 1-octene, 2-methyl-1-propene, 3-methyl-1l-pentene, 4-methyl-1-pentene, 5-methyl-1-hexene, and mixtures thereof. Copolymers of ethylene and propylene or ethylene or propylene with another α-olefin, such as 1-butene-1: pentene-1,2-methylpentene-1,3-methylbutene-1; hexene-1,3-methylpentene-1,4-methylpentene-1,3,3-dimethylbutene-1; heptene-1; hexene-1: methylhexene-1: dimethylpentene-1 trimethylbutene-1; ethylpentene-1; octene-1; methylpentene-1; dimethylhexene-1; trimethylpentene-1; ethylhexene-1; methylethylpentene-1: diethylbutene-1; propylpentane-1; decene-1; methylnonene-1; nonene-1; dimethyloctene-1: trimethylheptene-1; ethyloctene-1; methylethylbutene-1: diethylhexene-1 and dodecene-1, may also be used.

Where the thermoplastic polymer matrix is polypropylene, the matrix can vary widely in composition. For example, substantially isotactic polypropylene homopolymer or propylene copolymer containing 10 wt. % or less of a comonomer can be used (such as at least 90% by weight propylene). Further, polypropylene segments may be part of graft or block or random copolymers having a sharp melting point above 110° C. and alternatively above 115° C. and alternatively above 130° C., characteristic of the stereoregular propylene sequences. The continuous phase matrix may be a combination of homopolymer polypropylene, and/or random copolymer polypropylene, and/or block copolymers and/or impact copolymers polypropylenes as described herein. When the matrix is a random copolymer, the percentage of the copolymerized α-olefin in the copolymer is, in general, up to 9 wt. %, alternatively about 0.5 wt. % to about 8 wt. %, alternatively about 2 wt. % to about 6 wt. %. The preferred α-olefins contain 2 to 12 carbon atoms. One, two or more α-olefins can be copolymerized with propylene.

The continuous phase may be a polystyrene or polystyrene derivative SBC thermoplastic elastomer or thermoplastic polyurethane (TPU), or a combination of the above thermoplastic polyolefin with these thermoplastic elastomers. Examples of polystyrene thermoplastic elastomer may include, but are not limited to, the flexible block copolymer component, which is comprised of a block copolymer containing rigid blocks of vinyl aromatic monomers (S) and statistical, non-rigid mid-blocks of diene/vinyl aromatic monomers (B/S). These block copolymers contain at least the block structure S-B/S-S. The glass transition temperature (T_{g}) of block S is generally above 25° C. and that of the block B/S is generally below 25° C. The B/S block is composed of 75 wt. % to 30 wt. % vinyl aromatic monomer, and 25 wt. % to 70 wt. % diene monomer. Particularly preferred flexible B/S blocks have a vinyl aromatic monomer content of 60 wt. % to 40 wt. %, and a diene monomer content of 40 wt. % to 60 wt. % With respect to the total block copolymer component the diene content is less than 40 wt %, preferably 35 wt. %, and the portion of the non-rigid B/S blocks amounts to at least 50 wt. %, preferably 70 wt. %. The block copolymer component has a low modulus and yield strength, with high elongation.

Suitable vinyl aromatic monomers include styrene, alkyl-substituted styrenes such as p-methylstyrene, vinyltoluene, as well as mixtures of said monomers. Suitable diene monomers include 1,3-butadiene, isoprene, piperylene, phenylbutadiene, and mixtures of said monomers. The preferred monomer is 1,3-butadiene. The conjugated diene monomer can also be fully or partially hydrogenated. This type of flexible block copolymer is commercially exemplified in Styroflex® 2G66 (BASF A.G.).

The amount of the block copolymer component in the composition of the invention generally ranges from 3 wt. % to 25 wt. %, based on the total weight of the composition including the thermoplastic elastomer component, additives and the SBC component. The preferred amount of SBC ranges from 3 wt. % to 15 wt. %, with 5 wt. % to 10 wt. % being most preferred.

Thermoplastic polyurethane (TPU) includes thermoplastic elastomer copolymers including one or more polyurethane hard blocks or segments and one or more soft blocks. These copolymers may include those compositions obtained by reacting multi-functional isocyanate(s) with chain extender(s) and optionally macroglycol(s). Reactions may occur with an isocyanate index of at least 95, preferably at least 98; or at an isocyanate index of 105 or less, preferably 102 or less.

Thermoplastic polyurethane may include a blend of different thermoplastic polyurethanes in such amounts that the blend has at least one major T_{g} of less than 60° C.

In addition to the use of the random propylene copolymers and the SBC thermoplastic elastomers, the thermoplastic phase may additionally include polymeric modifiers of that thermoplastic phase. The polymeric modifiers specifically are those known to provide benefits in overall properties. For instance, long-chain branched thermoplastic resins compatible with the principle thermoplastic phase resin, e.g., polypropylene or high density polyethylene, can increase tensile strength and extensional viscosity, as well as other properties. Long-chain branched thermoplastic resins, which may be referred to herein as LCB-plastics, can generally be described as high molecular weight, highly branched polymers.

### Filler

The TPV compositions of the present disclosure may comprise fillers. Fillers can be inorganic fillers such as calcium carbonate, clays, silica, talc, titanium dioxide or carbon black, as well as organic and inorganic nanoscopic filler. For example, ICECAP-K® clay (anhydrous aluminum silicate clay, available from Burgess Pigment Company).

### Oil

The TPV compositions of the present disclosure may comprise an oil, such as paraffinic processing oils, Group II oils, mineral oils, and the like, and any combination thereof. These oils may also be referred to as plasticizers or extenders. Mineral oils may include aromatic, naphthenic, paraffinic, and isoparaffinic oils, synthetic oils, and the like, and any combination thereof. The mineral oils may be treated or untreated. Useful mineral oils can be obtained under the tradename SUNPAR™ (Sun Chemicals). Others are available under the name PARALUX™ (Chevron), and PARAMOUNT™ (Chevron). Other oils that may be used include hydrocarbon oils and plasticizers, such as organic esters and synthetic plasticizers. Many additive oils are derived from petroleum fractions, and have particular ASTM designations depending on whether they fall into the class of paraffinic, naphthenic, or aromatic oils. Other types of additive oils include α-olefinic synthetic oils, such as liquid polybutylene. Additive oils other than petroleum based oils can also be used, such as oils derived from coal tar and pine tar, as well as synthetic oils, e.g., polyolefin materials.

Examples of oils include base stocks, such as Group II oils, mentioned above. Group II oils are oils that have an oil having saturate content exceeding 90 wt. % of the TPV, a sulfur content of less than or equal to 0.03 wt. % of the TPV, and a viscosity index between 80 and 119. Group II stocks are derived from crude oil via extensive processing, as is known in the art. The synthetic oils may include synthetic polymers or copolymers having a viscosity of about 20 cP or more (such as about 40 cP to about 4,000 cP, such as about 100 cP to about 1,000 cP, such as about 190 cP to about 500 cP), where the viscosity is measured by a Brookfield viscometer according to ASTM D4402-15 at 38° C.

Useful synthetic oils can be commercially obtained under the tradenames POLYBUTENE™ (Soltex; Houston, Tex.), and INDOPOL™ (Ineos). White synthetic oil is available under the tradename SPECTRASYN™ (ExxonMobil), formerly SHF Fluids (Mobil), ELEVAST™ (ExxonMobil), and white oil produced from gas to liquid technology such as RISELLA™ X 415/420/430 (Shell) or PRIMOL™ (Exxonmobil) series of white oils, e.g., PRIMOL™ 352, PRIMOL™ 382, PRIMOL™ 542, or MARCOL™ 82, MARCOL™ 52, DRAKEOL® (Pencero) series of white oils, e.g., DRAKEOL® 34, and the like, and any combination thereof. Oils described in U.S. Pat. No. 5,936,028 may also be employed.

### Curing System

The rubber of the presently disclosed TPVs may be vulcanized using varying amounts of curative, varying temperatures, and varying time of cure in order to obtain the degree of crosslinking desired, as is known in the art. Any known cure systems may be used, so long as they are suitable under the vulcanization conditions for the elastomers being used, and are compatible with the thermoplastic polyolefin component. Suitable curatives include metal oxides, phenolic resin systems, maleimides, high energy radiation, and the like, both with and without accelerators and coagents. Cure systems used may be hydrosilylation, peroxide, silane grafting and moisture cure, and, preferably, a phenolic cure system.

The TPVs may be cured using a phenolic resin vulcanizing agent. The preferred phenolic resin curatives can be referred to as resole resins, which are made by the condensation of alkyl substituted phenols or unsubstituted phenols with aldehydes, preferably formaldehydes, in an alkaline medium or by condensation of bifunctional phenoldialcohols. The alkyl substituents of the alkyl substituted phenols may contain 1 to about 10 carbon atoms. Dimenthylolphenols or phenolic resins, substituted in para-positions with alkyl groups containing 1 to about 10 carbon atoms are preferred. A blend of octyl phenol and nonylphenol-formaldehyde resins may be employed. The blend may include from about 25 wt. % to about 40 wt. % octyl phenol, and from about 75 wt. % to about 60 wt. % nonylphenol, more preferably, the blend includes from about 30 wt. % to about 35 wt. % octyl phenol and from about 70 wt. % to about 65 wt. % nonylphenol. The blend may include about 33 wt. % octylphenolformaldehyde and about 67 wt. % nonylphenol formaldehyde resin, where each of the octylphenol and nonylphenol include methylol groups. This blend can be solubilized in paraffinic oil at about 30% solids.

Useful phenolic resins may be obtained under the tradenames SP-1044, SP-1045 (Schenectady International; Schenectady, N.Y.), which may be referred to as alkylphenolformaldehyde resins (also available in a 30/70 wt. % paraffinic oil solution under the trade name HRJ-14247A). SP-1045 is believed to be an octylphenol-formaldehyde resin that contains methylol groups. The SP-1044 and SP-1045 resins are believed to be essentially free of halogen substituents or residual halogen compounds. By “essentially free of halogen substituents,” it is meant that the synthesis of the resin provides for a non-halogenated resin that may only contain trace amounts of halogen containing compounds.

Preferred phenolic resins may have a structure according to the following general formula:

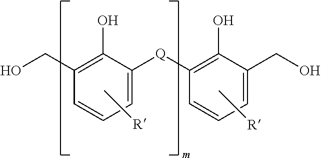

where Q is a divalent radical selected from the group consisting of —CH₂— and CH₂—O—CH₂—; m is zero or a positive integer from 1 to 20; and R₁ is an alkyl group. Preferably, Q is the divalent radical —CH₂—O—CH₂—, m is zero or a positive integer from 1 to 10, and R′ is an alkyl group having fewer than 20 carbon atoms. Still more preferably, m is zero or a positive integer from 1 to 5, and R′ is an alkyl group having between 4 and 12 carbon atoms.

Other examples of suitable phenolic resins include those described in U.S. Pat. Nos. 8,207,279 and 9,399,709.

The curative may be used in conjunction with a cure accelerator, a metal oxide, an acid scavenger, and/or polymer stabilizers. Useful cure accelerators include metal halides, such as stannous chloride, stannous chloride anhydride, stannous chloride dihydrate and ferric chloride. The cure accelerator may be used to increase the degree of vulcanization of the TPV, and may be added in an amount of less than 1 wt. % based on the total weight of the TPV. Preferably, the cure accelerator comprises stannous chloride. The cure accelerator may be introduced into the vulcanization process as part of a masterbatch.

Metal oxides may be added to the vulcanization process. It is believed that the metal oxide can act as a scorch retarder in the vulcanization process. Useful metal oxides include zinc oxides having a mean particle diameter of about 0.05 μm to about 0.15 μm. Useful zinc oxide can be obtained commercially under the tradename Kadox™ 911 (Horsehead Corp.).

The curative, such as a phenolic resin, may be introduced into the vulcanization process in a solution or as part of a dispersion. The curative may be introduced to the vulcanization process in an oil dispersion/solution, such as a curative-in-oil or a phenolic resin-in-oil, where the curative/resin is dispersed and/or dissolved in a process oil. The process oil used may be a mineral oil, such as an aromatic mineral oil, naphthenic mineral oil, paraffinic mineral oils, or combination thereof. The process oil used may be a low aromatic/sulfur content oil, as described herein, that has (i) an aromatic content of less than 5 wt. %, or less than 3.5 wt. %, or less than 1.5 wt. %, based on the weight of the low aromatic/sulfur content oil, and (ii) a sulfur content of less than 0.03 wt. %, or less than 0.003 wt. %, based on the weight of the low aromatic/sulfur content oil.

The method of dispersing and/or dissolving the curative, such as a phenolic resin, in the process oil may be any method known in the art. For example, the phenolic resin and process oil, such as a mineral oil and/or a low aromatic/sulfur content oil, may be fed together into a glass container equipped with a stirrer and heated while stirring on a water bath of 60° C. to 100° C. for 1 to 10 hours, as described in U.S. Pat. No. 9,399,709. For another example, the resin-in-oil dispersion may be made as part of the process for producing the phenolic resin, where the oil is a diluent in the manufacturing process.

### Additives

The presently disclosed compositions may include additives not discussed above, such as extenders, pigmentation agents, processing aids (e.g., slip agents), anti-static agents, antiblocking agents, flame retardants and the like. Any additive suitable for inclusion in a TPV may be incorporated. These additives may comprise up to about 50 wt. % of the total TPV composition.

The TPV formulation may include acid scavengers. These acid scavengers may be added to the thermoplastic vulcanizates after the desired level of cure has been achieved. The acid scavengers are added after dynamic vulcanization. Useful acid scavengers include hydrotalcites. Both synthetic and natural hydrotalcites can be used. An exemplary natural hydrotalcite can be represented by the formula Mg₆Al₂(OH)₁₆CO₃.4H₂O. Synthetic hydrotalcite compounds, which are believed to have the formula: Mg₄.3Al₂(OH)_{12.6}CO₃mH₂O or Mg_{4.5}Al₂(OH)₁₃CO₃.3.5H₂O, can be obtained under the tradenames DHT-4A® or KYOWAAD™ 1000 (polymer addition agents, available from Kyowa; Japan). Another commercial example is that available under the trade name ALCAMIZER® (halogen polymer stabilizer, available from Kyowa).

### Articles

The TPVs of the present disclosure have unexpectedly improved elastic performance and adhesion, bonding and tack characteristics which make them suitable for a wide variety of end uses, including those where improved elastomeric performance and strong adhesive properties or increased tack are required. For instance, TPV compositions of the present disclosure may be suitable for glass run channels, sponge weather seals, and soft or hard corner molding, TPVs used for corner molding need to exhibit excellent adhesion to surrounding surfaces, such as neighboring TPVs or rubber thermoset compound substrates. Further uses include automotive and other applications such as glass encapsulation, end caps, molded covers, cowl seals, applications requiring improved scratch and abrasion resistance, and for miscellaneous surface and material transitions. Specific automotive applications include hood-to-radiator seals, trunk/tailgate seals, and lips for air ducts. Beside automotive uses, TPV compositions of the present disclosure may be used in oil and gas applications, for instance as dynamic risers, flow lines and thermoplastic composite pipes where adhesion between neighboring polymer layers is important. Use of the TPVs is appropriate wherever outstanding bonding, tack or adhesive properties are desired, in addition to excellent elastomeric properties, flexibility, water resistance and hydrolytic stability.

The resulting TPVs exhibit a high degree of tack and high peel strength. For example, peel strength for bonding to teflon may exceed 0.05 N/in when measured according to the method described herein. Ranges are provided to account for experimental standard deviation.

The TPVs may be extruded, injected, or otherwise molded by conventional plastic processing equipment to press and shape TPVs into useful products. Thermoplastic vulcanizates can be prepared by dynamic vulcanization in BANBURY® mixers (available from HF Mixing Group and others), a mill, roll mixers, and other types of shearing, melt processing mixers. Because of the advantages of a continuous process, such materials can be prepared in single screw, twin screw or multi-screw extruders.

The hardness of the resulting TPV compositions covers a wide range of hardness. TPVs may range from 20 Shore A, to 50 Shore D. Preferably, the hardness is 50 Shore A to 70 Shore A, as measured using a Zwick automated durometer according to ASTM D2240-15e1 (15 sec. delay).

To facilitate a better understanding of the embodiments of the present invention, the following examples of preferred or representative embodiments are given. In no way should the following examples be read to limit, or to define, the scope of the invention.

### Test Protocols

Mooney viscosity: Mooney small thin viscosity (MST) (5+4) at 230° C. and Mooney small thin relaxation area (MSTRA) are determined using ASTM D1646.

Z-average (Mz), weight-average (Mw), number average molecular weights (Mn), viscosity average (Mv) molecular weights and the molecular weight of the highest peak (Mp) can be measured using gel permeation chromatography (GPC), also known as size exclusion chromatography (SEC). This technique utilizes an instrument containing columns packed with 20 porous beads, an elution solvent, and detector in order to separate polymer molecules of different sizes. In a typical measurement, the GPC instrument used is a Waters chromatograph equipped with ultrastyro gel columns operated at 145° C. The elution solvent used is trichlorobenzene. The columns are calibrated using sixteen polystyrene standards of precisely known molecular weights. A correlation of polystyrene retention volume obtained from the 25 standards, to the retention volume of the polymer tested yields the polymer molecular weight. Average molecular weights M (Mw, Mn, Mz) can be computed from known expressions. The desired MWD function (e.g., Mw/Mn or Mz/Mw) is the ratio of the corresponding M values. Measurement of M and MWD are well known in the art and are discussed in more detail in, for example, Slade, P. E. Ed., Polymer Molecular Weights Part II, 30 Marcel Dekker, Inc., NY, (1975) 287-368; Rodriguez, F., Principles of Polymer Systems 3rd Ed., Hemisphere Pub. Corp., NY, (1989) 155-160; U.S. Pat. No. 4,540,753; Ver Strate et al., Macromolecules, Vol. 21, (1988) pp. 3360-3371, each of which is incorporated herein by reference.

Peel force is measured as the force, given in units of N/in, required to cause delamination of the thermoplastic vulcanizate from a teflon surface as measured at ambient temperature of 23° C., a peel rate of 50 mm/min, a grip separation of 25 mm by taking the average in peel force over the plateau region, e.g., extension typically from 10 mm to 50 mm.

### EXPERIMENTAL

### Experiment 1

Three PEDM based TPVs of the present disclosure were made with a phenolic cure system at two curative levels (resin in oil and stannous chloride). Control TPVs, V3666-based TPVs (EP(ENB)DM) manufactured by ExxonMobil, were also provided. See Table 1. Characteristics of these TPVs were compared to the control, as shown in Table 2 below. The TPVs were made using a BRABENDER® processor (mixer, available from C.W. Brabender Instruments, Inc).

Formulations were as follows: A: V3666/6001R Oil II Control; B: PEDM 1, 10% C2, 5% ENB, Control formulation; C: PEDM 1, 10% C2, 5% ENB, 150% SnCl₂/150% RIO (resin in oil); D: PEDM 2, 20% C2, 5% ENB, Control formulation; E: PEDM 2, 20% C2, 5% ENB, 150% SnCl₂/150% RIO (resin in oil); F: PEDM 5, 30% C2, 5% ENB, Control formulation; G: PEDM 5, 30% C2, 5% ENB, 150% SnCl₂/150% RIO (resin in oil); H: PEDM 4, 40% C2, 5% ENB, Control formulation; I: PEDM 4, 40% C2, 5% ENB, 150% SnCl₂/150% RIO (resin in oil).

TABLE 1

| Formulations | A | B | C | D | E | F | G | H | I |
|---|---|---|---|---|---|---|---|---|---|
| VISTALON ™ V3666 (phr) | 175 | | | | | | | | |
| PEDM 1 | | 100 | 100 | | | | | | |
| PEDM 2 | | | | 100 | 100 | | | | |
| PEDM 5 | | | | | | 100 | 100 | | |
| PEDM 4 | | | | | | | | 100 | 100 |
| PP5341 | 26.97 | 26.97 | 26.51 | 26.97 | 26.51 | 26.97 | 26.51 | 26.97 | 26.51 |
| AMP 49974 | 23.96 | 23.96 | 23.96 | 23.96 | 23.96 | 23.96 | 23.96 | 23.96 | 23.96 |
| Clay (phr) | 42.00 | 42.00 | 42.00 | 42.00 | 42.00 | 42.00 | 42.00 | 42.00 | 42.00 |
| ZnO | 1.50 | 1.50 | 1.50 | 1.50 | 1.50 | 1.50 | 1.50 | 1.50 | 1.50 |
| Paramount 6001R | 13.10 | 13.10 | 13.10 | 13.10 | 13.10 | 13.10 | 13.10 | 13.10 | 13.10 |
| (pre-cure added) | | | | | | | | | |
| RIO HRJ16261 | 7.56 | 7.56 | 11.34 | 7.56 | 11.34 | 7.56 | 11.34 | 7.56 | 11.34 |
| (Paralux 6001R) | | | | | | | | | |
| SnCl₂ MB | 1.67 | 1.67 | 2.51 | 1.67 | 2.51 | 1.67 | 2.51 | 1.67 | 2.51 |
| Paramount 6001R | 55.72 | 55.72 | 53.07 | 55.72 | 53.07 | 55.72 | 53.07 | 55.72 | 53.07 |
| (post-cure added) | | | | | | | | | |
| Paramount 6001R | — | 75.00 | 75.00 | 75.00 | 75.00 | 75.00 | 75.00 | 75.00 | 75.00 |
| (extra oil added pre-cure | | | | | | | | | |
| to match oil contained | | | | | | | | | |
| in V3666 control rubber) | | | | | | | | | |
| Total Formulation phr | 347.48 | 347.48 | 349.00 | 347.48 | 349.00 | 347.48 | 349.00 | 347.48 | 349.00 |
| Total Oil phr | 149.11 | 149.11 | 149.11 | 149.11 | 149.11 | 149.11 | 149.11 | 149.11 | 149.11 |
| Total PP phr | 41.73 | 41.73 | 41.73 | 41.73 | 41.73 | 41.73 | 41.73 | 41.73 | 41.73 |
| Total rubber amount phr | 100.00 | 100.00 | 100.00 | 100.00 | 100.00 | 100.00 | 100.00 | 100.00 | 100.00 |

TABLE 2

| Formulations | A | B | C | D | E | F | G | H | I |
|---|---|---|---|---|---|---|---|---|---|
| Hardness, | 51.0 | 33.3 | 45.5 | 38.76 | 46.5 | 24.9 | 45.7 | 30.7 | 44.8 |
| Shore A (15 sec) | | | | | | | | | |
| 100% Modulus | 1.62 | 0.93 | 1.43 | 1.13 | 1.68 | 0.03 | 1.57 | | 1.68 |
| (MPa) | | | | | | | | | |
| Tensile Strength | 2.93 | 1.07 | 2.39 | 1.39 | 2.22 | 0.73 | 2.10 | 0.82 | 1.99 |
| (MPa) | | | | | | | | | |
| Ult. Elongation | 233 | 165 | 222 | 149.20 | 166 | 85 | 159 | 86 | 137 |
| (%) | | | | | | | | | |
| Tension Set @ 25% | 11.7 | 16.2 | 10.2 | 13.00 | 9.3 | 17.8 | 9.7 | 15.7 | 8.0 |
| (% set) | | | | | | | | | |
| Tension Set @ 50% | 25.5 | 32.7 | 19.3 | 25.00 | 17.5 | 36.7 | 18.2 | 31.8 | 16.0 |
| (% set) | | | | | | | | | |
| Swell in IRM903 | 111.4 | 146.1 | 109.4 | 131.2 | 105.3 | 149.5 | 107.0 | 143.8 | 108.6 |
| (% wt. gain) | | | | | | | | | |
| Specific gravity | 0.9679 | 0.9678 | 0.9699 | 0.97 | 0.9700 | 0.9680 | 0.9691 | 0.9691 | 0.9689 |

For Table 2, tension set for 25% elongation was measured elongation for 22 hours at 70° C., then releasing for 30 minutes before measurement. For Table 2, tension set for 50% elongation was measured for 22 hours at 70° C., then the formulation was taken out from the oven and cooled at ambient temperature under stress for 2 hours, then released for 30 minutes before measurement.

Swell in IRM903 was measured after 24 hours at 121° C. Specific gravity was measured at 23° C. General procedures for determining the percent compression are described in ASTM D 395-89. Tension set was determined according to ASTM D 412.

At a lower Mn, PEDM based TPVs (inventive examples B-I) surprisingly have improved elastic performance and lower tension set as compared to the control (comparative A), varying by curative level. With otherwise identical formulations, EPDM TPVs have a lower hardness level than control V3666-based TPVs. Thus, EPDM TPVs have improved suitability for adhesive and bonding applications as compared to the control. However, hardness of the TPV formulation can be controlled by adjusting the weight ratio of PEDM, PP and oil.

### Experiment 2

TPV formulations of the present disclosure were evaluated according to the below provided Table 3 and Table 4. Formulations were as follows: J: V3666 (Mn=126, Mw=509, C2=64, ENB=4.2); K: V3666 (Mn=126, Mw=509, C2=64, ENB=4.2) Hi Cure; L: PEDM (Mn=71, Mw=154, C2=15, ENB=2.8); M: PEDM (Mn=71, Mw=154, C2=15, ENB=2.8) Hi Cure; N: PEDM (Mn=99, Mw=260, C2=5, ENB=2.5); 0: PEDM (Mn=99, Mw=260, C2=5, ENB=2.5) Hi Cure; P: PEDM (Mn=80, Mw=161, C2=5, ENB=3); Q: PEDM (Mn=80, Mw=161, C2=5, ENB=3) Hi Cure; R: PEDM (Mn=136, Mw=300, C2=5, ENB=3); S: PEDM (Mn=136, Mw=300, C2=5, ENB=3) Hi Cure; T: PEDM (Mn=70, Mw=158, C2=14.5, ENB=2); U: PEDM (Mn=70, Mw=158, C2=14.5, ENB=2) Hi Cure; V: V2504 (Mn=51, Mw=167, C2=58, ENB=4.7); W: V2504 (Mn=51, Mw=167, C2=58, ENB=4.7) Hi Cure.

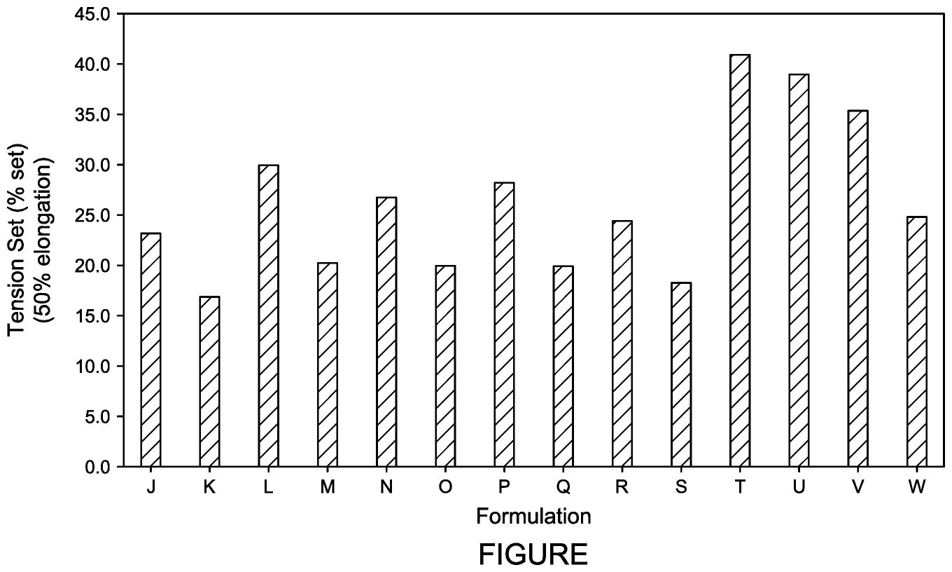

FIG. 1 is a graph illustrating the tension set values given below for the above formulations.

TABLE 3

| | J | K | L | M | N | O | P |
|---|---|---|---|---|---|---|---|
| Mn (kg/mol) of rubber before crosslinking | 126 | 126 | 71 | 71 | 99 | 99 | 80 |
| Mw (kg/mol) of rubber before crosslinking | 509 | 609 | 154 | 154 | 260 | 260 | 161 |
| % C2 | 64 | 64 | 15 | 15 | 5 | 5 | 5 |
| % ENB | 4.2 | 4.2 | 2.8 | 2.8 | 2.5 | 2.5 | 3 |
| Hardness Shore A | 52 | 55 | 33 | 41 | 38 | 43 | 33 |
| 100% Modulus | 1.6 | 2.1 | 0.9 | 1.3 | 1.1 | 1.4 | 1.0 |
| Tens. Strength, MPa | 3.2 | 4.9 | 1.0 | 2.3 | 1.8 | 2.6 | 1.6 |
| Ult. Elongation, % | 251 | 301 | 134 | 242 | 270 | 243 | 283 |
| Tension Set, % set (25% Elongation) | 10.7 | 8.5 | 15.0 | 10.5 | 13.7 | 10.8 | 14.5 |
| 22 hrs @70° C., Release for 30 minutes | | | | | | | |
| then measure | | | | | | | |
| Tension Set, % set (50% Elongation) | 23.2 | 16.8 | 30.0 | 20.2 | 26.8 | 19.8 | 28.2 |
| 22 hrs @70° C., Take out under stress for | | | | | | | |
| 2 hrs, release for 30 minutes then measure | | | | | | | |
| Swell in IRM903, 24 hrs, @121° C., % wt. gain | 95 | 72 | 132 | 100 | 115 | 94 | 125 |
| Specific Gravity @23° C. | 0.969 | 0.970 | 0.970 | 0.971 | 0.970 | 0.970 | 0.970 |
| Peel strength, bond to Teflon (N/in) | 0.29 | — | 0.77 | — | 0.63 | — | 0.44 |

TABLE 4

| | Q | R | S | T | U | V | W |
|---|---|---|---|---|---|---|---|
| Mn (kg/mol) of rubber before crosslinking | 80 | 136 | 136 | 70 | 70 | 51 | 51 |
| Mw (kg/mol) of rubber before crosslinking | 161 | 300 | 300 | 158 | 158 | 167 | 167 |
| % C2 | 5 | 5 | 5 | 14.5 | 14.5 | 58 | 58 |
| % ENB | 3 | 3 | 3 | 2 | 2 | 4.7 | 4.7 |
| Hardness Shore A | 40 | 41 | 45 | 21 | 20 | 33 | 43 |
| 100% Modulus | 1.3 | 1.2 | 1.4 | 0.7 | 0.7 | 0.9 | 1.2 |
| Tens. Strength, MPa | 3.0 | 2.9 | 3.6 | 0.7 | 0.7 | 0.9 | 1.2 |
| Ult. Elongation, % | 311 | 418 | 343 | 109 | 144 | 116 | 103 |
| Tension Set, % set (25% Elongation) | 10.0 | 13.2 | 10.0 | 18.8 | 18.7 | 17.3 | 12.5 |
| 22 hrs @70° C., Release for 30 minutes | | | | | | | |
| then measure | | | | | | | |
| Tension Set, % set (50% Elongation) | 19.8 | 24.3 | 18.3 | 41.2 | 39.0 | 35.5 | 24.8 |
| 22 hrs @70° C., Take out under stress for | | | | | | | |
| 2 hrs, release for 30 minutes then measure | | | | | | | |
| Swell in IRM903, 24 hrs, @121° C., % wt. gain | 94 | 107 | 86 | 88 | 91 | 143 | 110 |
| Specific Gravity @23° C. | 0.969 | 0.962 | 0.965 | 0.967 | 0.964 | 0.969 | 0.969 |
| Peel strength, bond to Teflon (N/in) | — | 0.18 | — | — | — | 0.63 | 0.22 |

All documents described herein are incorporated by reference herein, including any priority documents and/or testing procedures to the extent they are not inconsistent with this text. As is apparent from the foregoing general description and the specific embodiments, while forms of the embodiments have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “I”” preceding the recitation of the composition, element, or elements and vice versa, e.g., the terms “comprising,” “consisting essentially of,” “consisting of” also include the product of the combinations of elements listed after the term.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present disclosure. Further, all documents and references cited herein, including testing procedures, publications, patents, journal articles, etc. are herein fully incorporated by reference for all jurisdictions in which such incorporation is permitted and to the extent such disclosure is consistent with the description of the present disclosure.

While the present disclosure has been described with respect to a number of embodiments and examples, those skilled in the art, having benefit of the present disclosure, will appreciate that other embodiments can be devised which do not depart from the scope and spirit of the present disclosure as described herein.

1-98. (canceled)

99. A thermoplastic vulcanizate (TPV) composition comprising:
a thermoplastic phase that comprises a thermoplastic polyolefin; and
a rubber phase that comprises an amorphous propylene-ethylene copolymer having: a Mₙ of from 20 kg/mol to 3,000 kg/mol, a M_{w}/Mₙ of 10.0 or lower, an ethylene percentage by weight of from about 2 wt. % to about 50 wt. %, a diene percentage by weight of from about 0 wt. % to about 21 wt. % and a heat of fusion of less than 5 J/g.

100. The TPV of claim 99, wherein the amorphous propylene-ethylene copolymer comprises at least 50% by weight of the rubber phase.

101. The TPV of claim 99, wherein the amorphous propylene-ethylene copolymer comprises from about 20 wt. % to about 80 wt. % of the TPV.

102. The TPV of claim 99, wherein the amorphous propylene-ethylene terpolymer has a Mₙ of from 50 kg/mol to 1,000 kg/mol.

103. The TPV of claim 99, wherein the M_{w}/Mₙ of the amorphous propylene-ethylene copolymer is 8.0 or lower.

104. The TPV of claim 99, wherein the ethylene percentage by weight of the amorphous propylene-ethylene copolymer is from about 10 wt. % to about 40 wt. %.

105. The TPV of claim 99, wherein the diene percentage of the amorphous propylene-ethylene copolymer by weight is from about 4 wt. % to about 10 wt. %.

106. The TPV of claim 99, wherein the amorphous propylene-ethylene terpolymer comprises 3 to 50 percent by weight ethylene units, and 2 to 12 percent by weight 5-ethylidene-2-norbornene derived units.

107. The TPV of claim 99, wherein the amorphous propylene-ethylene terpolymer has a heat of fusion (H_{f}) which is less than 0.5 J/g.

108. The TPV of claim 99, wherein the amorphous propylene-ethylene terpolymer has no detectable heat of fusion (H_{f}) when measured by a differential scanning calorimeter.

109. The TPV of claim 99, wherein a crystallinity of the amorphous propylene-ethylene copolymer is from 0 to 5 percent.

110. The TPV of claim 99, wherein the amorphous propylene-ethylene copolymer has a Dry Mooney viscosity of about 10 to about 500 ML(1+4) at 125° C.

111. The TPV of claim 99, wherein the amorphous propylene-ethylene terpolymer has a viscosity of MST (5+4)@230° C. from 5 to 90.

112. The TPV of claim 99, wherein the rubber phase comprises less than 50 percent by weight of a butyl or an ethylene-propylene-diene rubber.

113. The TPV of claim 99, wherein the rubber phase comprises a propylene-ethylene-diene terpolymer.

114. The TPV of claim 99, wherein the thermoplastic polyolefin is a polypropylene.

115. The TPV of claim 99, wherein the thermoplastic polyolefin is a polyethylene.

116. The TPV of claim 99, wherein the thermoplastic polyolefin is a polypropylene homopolymer with a long chain branching index between 0.5 and 1.

117. The TPV of claim 99, wherein the thermoplastic phase has a melt flow rate from about 0.1 g/10 min to about 20 g/10 min.

118. The TPV of claim 99, wherein the thermoplastic phase has a molecular weight of about 100 kg/mol to about 1,000 kg/mol.

119. The TPV of claim 99, further comprising one or more fillers selected from the list of: calcium carbonate, clays, silica, talc, titanium dioxide, carbon black, and organic and inorganic nanoscopic fillers.

120. The TPV of claim 99, further comprising a plasticizer or oil.

121. The TPV of claim 120, wherein the plasticizer or oil comprises a mineral oil, a synthetic oil, an ester plasticizer or any combination thereof.

122. The TPV of claim 121, wherein the mineral oil comprise an aromatic oil, a naphthenic oil, a paraffinic oil, an isoparaffinic oil, a synthetic oil, or any combination thereof.

123. The TPV of claim 99, further comprising a curing system.

124. The TPV of claim 123, wherein the curing system includes a phenolic curing resin and a cure accelerator.

125. The TPV of claim 124, wherein the cure accelerator is stannous chloride.

126. The TPV of claim 123, wherein the curing system comprises peroxide.

127. The TPV of claim 123, wherein the curing system is a silane grafting and moisture curing system.

128. The TPV of claim 99, wherein the hardness is from about 20 Shore A to about 60 Shore D.

129. The TPV of claim 99, wherein the hardness is from about 50 Shore A to about 80 Shore A.

130. The TPV of claim 99, wherein the peel force of the TPV when bonded to Teflon is from 0.05 N/in to 2 N/in.

131. The TPV of claim 99, wherein the tension set at 25% (70° C.) elongation is from 5% to 20%.

132. An article comprising the TPV composition of claim 99.

133. The article of claim 132, wherein the article is selected from the group consisting of GCR weather seals, corner moldings, seals, gaskets, flexible pipe for petroleum application, and thermoplastic composite pipe suitable for petroleum applications.

134. A method for preparing the TPV of claim 99 comprising:
introducing into a blender each of
the thermoplastic phase that comprises the thermoplastic polyolefin;
the rubber phase that comprises the amorphous propylene-ethylene copolymer having: a Mₙ of from 20 kg/mol to 3,000 kg/mol, a M_{w}/Mₙ of 10.0 or lower, an ethylene percentage by weight of from about 2 wt. % to about 50 wt. %, a diene percentage by weight of from about 0 wt. % to about 21 wt. % and a heat of fusion of less than 5 J/g; and
dynamically vulcanizing at least a portion of the contents of the blender so as to form the thermoplastic vulcanizate.
